(19) United States
(12) Patent Application Publication
(10) Pub. No.: US 2025/0046816 A1
(43) Pub. Date: Feb. 6, 2025

(54) METHOD FOR PRODUCING A GRANULAR CARBON-SILICON COMPOSITE FROM A LIGNIN-SILICON COMPOSITE

(71) Applicant: Stora Enso OYJ, Helsinki (FI)

(72) Inventors: Vilhelm Olsson, Täby (SE); Stephan Walter, Bochum (DE); Mario Wachtler, Strängnäs (SE)

(73) Assignee: Stora Enso OYJ, Helsinki (FI)

(21) Appl. No.: 18/717,640

(22) PCT Filed: Dec. 7, 2022
(86) PCT No.: PCT/IB2022/061883

§ 371 Date: Jun. 7, 2024

(30) Foreign Application Priority Data
Dec. 10, 2021 (SE) 2151513-5

(51) Int. Cl. H01M 4/587; C04B 35/524; C04B 35/626; C04B 35/636; C04B 35/64

(52) U.S. Cl. CPC H01M 4/587; C04B 35/524; C04B 35/6261; C04B 35/62675; C04B 35/62695; C04B 35/636; C04B 35/64; C04B 2235/3418; C04B 2235/422; C04B 2235/428; C04B 2235/5427; C04B 2235/608; C04B 2235/6567; C04B 2235/661

(57) ABSTRACT

The present invention is directed to a method for producing an agglomerated lignin-silicon composite material. The method involves the steps of mixing lignin in powder form, at least one silicon-containing active material in powder form and optionally at least one additive; compacting the mixture; and crushing the compacted composite material to obtain an agglomerated lignin-silicon composite material. The invention is also directed to a granular carbon-silicon composite material obtained by heat treatment of the agglomerated lignin-silicon composite material.

### FIELD OF THE INVENTION

The present invention relates to a method for producing an agglomerated lignin-silicon composite material, and an agglomerated lignin-silicon composite material obtainable by the method. The present invention further relates to a method for obtaining a granular carbon-silicon composite material from said agglomerated lignin-silicon composite material. The present invention further relates to a carbon-silicon composite material powder obtainable from said granular carbon-silicon composite material, and a negative electrode for a non-aqueous secondary battery comprising said carbon-silicon composite material powder as active material. The invention further relates to use of said carbon-silicon composite material powder as active material in a negative electrode of a non-aqueous secondary battery.

### BACKGROUND

Secondary batteries, such as lithium-ion batteries, are electrical batteries which can be charged and discharged many times, i.e. they are rechargeable batteries. In lithium-ion batteries, lithium ions flow from the negative electrode through the electrolyte to the positive electrode during discharge, and back when charging. Today, typically a lithium compound, in particular a lithium metal oxide such as lithium nickel manganese cobalt oxide (NMC) or alternatively a lithium iron phosphate (LFP) is utilized as material of the positive electrode and a carbon enriched material is utilized as material of the negative electrode.

Graphite (natural or synthetic graphite) is today utilized as material of the negative electrode in most lithium-ion batteries due to their high energy density and stable charge/discharge performance over time. An alternative to graphite is amorphous carbon materials, such as hard carbons (non-graphitizable amorphous carbons) and soft carbons (graphitizable amorphous carbons), which lack long-range graphitic order. Common to graphite and amorphous carbons is that the volume changes during charge and discharge are small.

This results in a good mechanical stability of the electrode material and helps to maintain good cycling stability. Amorphous carbons can be used as sole active electrode materials or in mixtures with graphite. Hard carbons often have good charge/discharge rate performance which is desired for fast charging and high-power systems.

Amorphous carbons can be derived from lignin. Lignin is an aromatic polymer, which is a major constituent in e.g. wood and one of the most abundant carbon sources on earth. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry. Amorphous carbons derived from lignin are typically non-graphitizable, i.e. hard carbons.

However, hard carbons usually exhibit lower usable energy density compared to graphite, which currently limits their wider use as the anode material in lithium ion batteries.

Silicon has a high specific charge capacity (the theoretical capacity is 3579 mAh/g corresponding to Li₁₅Si₄), compared to carbon (372 mAh/g, LiC₆) and could therefore be used to increase the energy density of carbon-based (graphite and/or amorphous) anode materials. Thus, in principle addition of silicon could be used to compensate for the lower energy density of amorphous carbon (such as hard carbons) compared to graphite.

A drawback with silicon as electrode material is the large volumetric expansion that occurs during charging and discharging of silicon. The large volumetric expansion of silicon poses a challenge that leads to high irreversible capacities and insufficient cycling behavior. To mitigate this problem, it is envisioned that silicon can be encapsulated inside a carbon matrix to reduce the impact of volumetric expansion and thereby reduce irreversible capacity loss and improve charge/discharge cycling behavior.

Silicon can be used in the form of elemental silicon, or as a silicon suboxide (SiOₓ), or as a silicon alloy (such as SiMₓC_{z}, with M being a metal). The silicon or silicon-rich compounds are herein commonly denoted as silicon-containing materials or SiX.

Commercial composite materials of carbon and Six, e.g. composite materials of graphite and Six, are today typically produced by methods comprising any one of the following steps:
mixing of graphite and SiX before electrode preparation, using for instance, high energy mixing or milling techniques
coating of graphite with thin layers of a silicon-containing material, e.g. by chemical vapor deposition (CVD), to obtain graphite/SiX core/shell materials
coating of Six particles with thin carbon layers, e.g. by wet-chemical methods, to obtain SiX/carbon core/shell materials
blending of graphite with Six during electrode preparation

The component of Six in the methods mentioned above may be surface pre-oxidized or carbon coated to increase its stability. Furthermore, the carbon/Six composite material may be additionally carbon-coated to increase its stability.

When utilized as a material in an electrode of a secondary battery, the composite materials of graphite and Six are commonly provided in powder form and mixed with a binder to form the electrode.

US20140287315 A1 describes a process for producing an Si/C composite, which includes providing an active material containing silicon, providing lignin, bringing the active material into contact with a C precursor containing lignin and carbonizing the active material by converting lignin into carbon at a temperature of at least 400° C. in an inert gas atmosphere. The silicon-based active material can be subjected to milling together with lignin or be physically mixed with lignin.

However, in composite materials of graphite/carbon and Six obtained by methods such as milling or coating, such as those mentioned above, the single components are typically present next to each other (Six next to graphite/carbon), or on top of each other (Six on top of the surface of graphite/carbon or graphite/carbon on top of the surface of Six). Thus, the amount of Six loading, while maintaining a good and uniform dispersion of Si, is limited. Furthermore, unless Six or the composite of graphite/carbon and Six are carbon coated, SiX will be in direct contact with the binder and the electrolyte of the battery, giving rise to problems with cycling stability. Special binders and electrolytes are thereby required.

To overcome these problems, one strategy is to embed Six in a carbon pre-cursor to create a C/SiX composite upon conversion to a carbon enriched material.

As mentioned above, hard carbon can be obtained using lignin as a starting material. Today, the most commercially relevant source of lignin is Kraft lignin, obtained from hardwood or softwood through the kraft process. The lignin can be separated from alkaline black liquor using for example membrane- or ultrafiltration. One common separation process is described in WO2006031175 A1. In this process lignin is precipitated from alkaline black liquor by addition of acid and then filtered off. The lignin filter cake is in the next step re-slurried under acidic conditions and washed prior to drying and pulverization.

One problem with using lignin as a precursor for a carbon enriched material is that direct use of lignin, in the form of a fine powder, is not suitable since it exhibits undesired thermoplastic behaviour. During thermal conversion of lignin powder into a carbon enriched material, lignin undergoes plastic deformation/melting, aggressive swelling and foaming. This severely limits processability of lignin in an industrially relevant scale, in terms of equipment dimensioning and process throughput as well as need of intermediate processing.

Thus, there is still room for improvements of methods for producing a carbon-silicon composite material with a high-loading of silicon as well as a good and uniform dispersion of Si in the carbon matrix. The method should enable use of lignin in powder form and thus avoid that lignin undergoes plastic deformation/melting, aggressive swelling and foaming upon heating to obtain the carbon-silicon composite material. In addition, it should be possible to use the method in large-scale manufacturing.

### SUMMARY OF THE INVENTION

It is an object of the present invention to provide an improved method for producing a carbon-silicon composite material, which method allows use of a renewable carbon source, and which method eliminates or alleviates at least some of the disadvantages of the prior art methods.

It is a further object of the present invention to provide a method for producing an improved carbon-silicon composite material suitable for use as active material in the negative electrode of a secondary battery, such as a lithium-ion battery.

It is a further object of the present invention to provide a method for producing a carbon-silicon composite material with a high loading of silicon as well as a good and uniform dispersion of silicon in the carbon matrix.

It is a further object of the present invention to provide a method for producing a carbon-silicon composite material, which method allows use of lignin in powder form while the shape and dimension of the lignin is maintained during subsequent heat treatment.

It is a further object of the present invention to provide a method for producing a carbon-silicon composite material, which method is scalable and thus suitable for large-scale manufacturing.

The above-mentioned objects, as well as other objects as will be realized by the skilled person in light of the present disclosure, are achieved by the various aspects of the present disclosure.

According to a first aspect, the present invention relates to a method for producing an agglomerated lignin-silicon composite material, said method comprising the steps of:
a) providing lignin in the form of a powder;
b) providing at least one silicon-containing active material in the form of a powder;
c) mixing the lignin powder, the at least one silicon-containing active material powder, and optionally at least one additive so as to obtain a lignin-silicon powder mixture;
d) compacting the lignin-silicon powder mixture obtained in step c) so as to obtain a lignin-silicon composite material;
e) crushing the lignin-silicon composite material obtained in step d) so as to obtain an agglomerated lignin-silicon composite material;
f) optionally sieving the agglomerated lignin-silicon composite material obtained in step e) so as to remove particles having a particle diameter below 100 μm, and obtain an agglomerated lignin-silicon composite material having a particle size distribution such that at least 80 wt % of the agglomerates have a diameter within the range of from 0.2 mm to 5.0 mm.

It has surprisingly been found that a silicon-containing active material may be directly dispersed in a lignin matrix by mixing followed by compaction and agglomeration, thus obtaining an agglomerated lignin-silicon composite material with a high loading of silicon as well as a uniform dispersion of silicon in the lignin matrix.

In addition, it has surprisingly been found that lignin which has undergone compaction and agglomeration into macroscopic particles can be heat treated with retained shape and dimension, avoiding melting/swelling and deformation. The agglomerated lignin-silicon composite material thus has a good thermal processability which makes it suitable as precursor for industrial scale production of carbon-silicon composite materials.

According to a second aspect, the present invention relates to an agglomerated lignin-silicon composite material obtainable by the method according to the first aspect.

According to a third aspect, the present invention relates to a method for producing a granular carbon-silicon composite material, comprising the steps of:
i) providing an agglomerated lignin-silicon composite material obtainable by the method according to the first aspect;
ii) subjecting the agglomerated lignin-silicon composite material to heat treatment at one or more temperatures in the range of from 300° C. to 1500° C., wherein the heat treatment is carried out for a total time in the range of from 30 minutes to 10 hours, so as to obtain a granular carbon-silicon composite material.

It has surprisingly been found that production of a carbon-silicon composite material with lignin as the carbon precursor is facilitated by providing the lignin-silicon composite in the form of an agglomerated lignin-silicon composite material, as the agglomerated lignin-silicon composite material will retain its dimensional integrity during further heat treatments to obtain the carbon-silicon composite material.

In addition, the uniform distribution of silicon within the agglomerated lignin-silicon composite material will be retained after conversion to a carbon enriched material. Thus, the obtained granular carbon-silicon composite material will also have a uniform distribution of silicon which renders the material suitable for further processing to an active material in a negative electrode of a secondary battery.

According to a fourth aspect, the present invention relates to a granular carbon-silicon composite material obtainable by the method according to the third aspect.

According to a fifth aspect, the present invention relates to a carbon-silicon composite material powder obtained by pulverizing the granular carbon-silicon composite material obtainable by the method according to the third aspect.

The uniform distribution of silicon within the carbon will remain also after pulverization. The obtained carbon-silicon composite material powder is thus suitable for use as active material in a negative electrode of a secondary battery.

According to a sixth aspect, the present invention relates to a negative electrode for a non-aqueous secondary battery comprising the carbon-silicon composite material powder according to the fifth aspect as active material.

According to a seventh aspect, the present invention relates to use of the carbon-silicon composite material powder according to the fifth aspect as active material in a negative electrode of a non-aqueous secondary battery.

### DETAILED DESCRIPTION

According to a first aspect, the present invention relates to a method for producing an agglomerated lignin-silicon composite material. Step a) of the method according to the first aspect of the present invention involves providing lignin in the form of a powder.

The term “lignin” as used herein, refers to any kind of lignin which may be used as the carbon source for making a carbonized granular carbon-silicon composite material. Examples of said lignin are, but are not limited to, lignin obtained from vegetable raw material such as wood, e.g. softwood lignin, hardwood lignin, and lignin from annular plants. Also, lignin can be chemically modified.

Preferably, the lignin has been purified or isolated before being used in the process according to the present disclosure. The lignin may be isolated from black liquor and optionally be further purified before being used in the process according to the present disclosure. The purification is typically such that the purity of the lignin is at least 90%, preferably at least 95%. Thus, the lignin used according to the method of the present disclosure preferably contains less than 10%, more preferably less than 5%, impurities such as e.g. cellulose, ash, and/or moisture.

Preferably, the carbon-containing precursor contains less than 1% ash, more preferably less than 0.5% ash.

The lignin may be obtained through different fractionation methods such as an organosolv process or a Kraft process. For example, the lignin may be obtained by using the process disclosed in WO2006031175 A1.

Preferably, the lignin provided in step a) of the method according to the first aspect is Kraft lignin, i.e. lignin obtained through the Kraft process. Preferably, the Kraft lignin is obtained from hardwood or softwood, most preferably from softwood.

The lignin in powder form provided in step a) is preferably dried before mixing with the at least one silicon-containing active material. The drying of the lignin powder is carried out by methods and equipment known in the art. In one embodiment, the lignin in powder form used in step a) has a moisture content of less than 45 wt %. Preferably, the moisture content of the lignin before mixing with the at least one silicon-containing active material according to the present invention is less than 25 wt %, preferably less than 10 wt %, more preferably less than 8 wt %. In one embodiment, the moisture content of the lignin before mixing with the at least one silicon-containing active material according to the present invention is at least 1 wt %, such as at least 5 wt %. The temperature during the drying is preferably in the range of from 80° C. to 160° C., more preferably in the range of from 100° C. to 120° C.

In one embodiment, the particle size distribution of the lignin in the form of a powder is such that at least 80 wt % of the particles have a diameter less than 0.2 mm. The lignin powder obtained after drying has a wide particle size distribution ranging from 1 μm to 2 mm which is significantly skewed towards the micrometer range, meaning that a significant proportion of the particles has a diameter in the range of 1 to 200 μm.

In one embodiment, the particle size distribution of the lignin in the form of a powder is such that at least 80 wt % of the particles have a diameter less than 0.2 mm and a moisture content of less than 45 wt %.

The lignin powder, prior to mixing with the at least one silicon-containing active material, preferably has a bulk density in the range of from 0.3 g/cm³ to 0.4 g/cm³.

Step b) of the method according to the first aspect involves providing at least one silicon-containing active material in the form of a powder.

The term “silicon-containing active material” (SiX), as used herein, refers to a material containing silicon which can be used as a (battery) capacity enhancing material in carbon-silicon composite materials and thus may be used for making a carbonized carbon-silicon composite material.

The term “silicon-containing active material” (SiX), as used herein, encompasses both pure elemental Si and Si-rich compounds. Si-rich compounds comprise silicon dioxide (SiO₂), Si suboxide (SiOx, with 0≤x≤2), Si alloys (such as e.g. SiFex, SiFexAly, or SiFexCy), and other compounds which are rich in Si, such as silicates. Different models have been proposed to describe the structure of SiOx. Most commonly SiOx is described as a mixture of Si and SiO₂ interdispersed on a nanometric scale The silicon-containing active material (SiX) mentioned above may be provided in crystalline or amorphous form and may, in addition, be surface pre-oxidized or carbon coated to increase stability.

The at least one silicon-containing active material in particulate form is mixed with the lignin in the form of a powder. In some embodiments each silicon-containing active material utilized is selected from the group of: elemental silicon, a silicon suboxide, a silicon-metal alloy or a silicon-metal carbon alloy. The silicon suboxide may be SiOx with 0≤x≤2. The silicon-metal alloy may be any suitable silicon-metal alloy, such as e.g. SiFex or SiFexAly. The silicon-metal carbon alloy may be e.g. SiFexCy.

In some embodiments, one silicon-containing active material is utilized, i.e. the step of providing at least one silicon-containing active material comprises providing one silicon-containing active material.

In some embodiments, more than one silicon-containing active material is utilized, i.e. the step of providing at least one silicon-containing active material comprises providing two, three, four or more silicon-containing active materials. Each silicon-containing active material may then be selected from the silicon-containing active materials mentioned above.

The silicon-containing active material is provided in the form of a powder, preferably the silicon-containing active material is microsized or nanosized. By “microsized” is herein meant that the silicon-containing active material is in particulate form, with particles having an average particle size in the micrometer range, such as e.g. 1-50 μm. By “nanosized” is herein meant that the silicon-containing active material is in particulate form, with particles having an average particle size in the nanometer range, such as e.g. 1-999 nm.

Typically, the average particle size of the silicon-containing active material in the form of a powder may be between 5 nm and 5 μm.

The at least one silicon-containing active material is preferably dried before mixing with the lignin in powder form. The drying of the silicon-containing active material is carried out by methods and equipment known in the art. In one embodiment, the silicon-containing active material used in step b) has a moisture content of less than 20 wt %, such as less than 10 wt %.

Step c) of the method according to the first aspect involves mixing the lignin powder, the at least one silicon-containing active material powder, and optionally at least one additive so as to obtain a lignin-silicon powder mixture.

The mixing is performed by methods and equipment as known in the art. One example of a suitable method is a vertical mixer, such as paddle, screw or ribbon-screw mixer in a batch or continuous mode. The mixing process may be carried out in a low-, medium- or high-shear impact mode.

In some embodiments, at least one additive may be added during or prior to mixing. Any suitable additives, such as binders or lubricants, may be added to facilitate the subsequent compaction process and to improve the density and mechanical properties of the obtained lignin-silicon composite material. In addition, additives having an influence on the properties of the final material may be added, such as functionality-enhancing additives. The total amount of additive(s) is preferably less than 5 wt %, such as from 0 to 5 wt %, or from 0.1 to 5 wt %, or less than 2 wt %, such as from 0 to 2 wt %, or from 0.1 to 2 wt %, as based on the total dry weight of the lignin-silicon powder mixture.

In some embodiments, the mixing is performed during at least 1 minute, or at least 10 minutes, or at least 15 minutes. In some embodiments, the mixing is performed in the range of from 1 to 60 minutes, or from 1 to 30 minutes, or from 1 to 10 minutes. The dispersion of the at least one silicon-containing active material within the lignin matrix is improved by increasing the mixing time.

In some embodiments, the mixing is performed at a mixing speed of at least 100 rpm, such as at least 200 rpm or at least 300 rpm. In some embodiments, the mixing speed is in the range of from 100 to 3000 rpm, or from 100 to 1500 rpm, or from 100 to 1000 rpm. The dispersion of the at least one silicon-containing active material within the lignin matrix is improved by increasing the mixing speed.

During mixing, the temperature of the mixture may increase due to friction. In one embodiment, the temperature of the powders during mixing is maintained in a range of from 20 to 100° C. The temperature can be maintained by means of heating or cooling the apparatus used for mixing.

As mentioned above, the dispersion of the at least one silicon-containing active material within the lignin matrix is improved both by a sufficient mixing time, a suitable mixing speed and a suitable mixing temperature so that a uniform distribution of the at least one silicon-containing active material within the lignin matrix is achieved. A uniform dispersion in the lignin-silicon powder mixture ensures a uniform dispersion also after compaction, in the formed agglomerates.

The degree of dispersion of the at least one silicon-containing active material in the lignin matrix may be controlled by appropriate selection of the amount of the at least one silicon-containing active material that is added to the lignin powder, the particle size(s) of the at least one silicon-containing active material and the mixing parameters such as mixing speed, mixing time and mixing temperature. For example, when using silicon-containing active material(s) of nanosize, the particles of the silicon-containing active material may be strongly aggregated. Thus, in order to break the aggregates and disperse the silicon-containing active material in the lignin matrix, a high mixing speed is required.

A uniform dispersion in the lignin-silicon powder mixture ensures a uniform dispersion also after compaction, in the formed agglomerates. As the dispersion of the silicon-containing active material is maintained after conversion to a carbon enriched material, a granular carbon-silicon composite material having a uniform dispersion of silicon-containing active material within the carbon matrix is obtained. This material is in turn, after pulverization, suitable for use as active material in a negative electrode of a secondary battery. Use of a carbon-silicon composite material having a uniform dispersion of silicon-containing active material within the carbon matrix as active material in the negative electrode of a secondary battery is advantageous since the uniform dispersion implies that it is possible to obtain more uniform properties of the active material, and thus the electrode, compared to when using a material lacking a uniform dispersion of silicon-containing active material. For example, the volume change of the electrode during charge and discharge may be more uniform when the dispersion of silicon-containing active material within the carbon matrix is uniform.

In one embodiment, mixing of the lignin powder and the at least one silicon-containing active material in the form of a powder is performed at the same time as milling of the powder(s) in order to reduce the particle size of the powder particles. Milling can be performed by methods such as impact milling, hammer milling, ball milling and jet milling.

Mixing of the lignin powder and the at least one silicon-containing active material in the form of a powder may be performed using any suitable equipment known in the art. For example, if a particular high level of mixing is desired to simultaneously de-agglomerate and break down lignin particles and particles of silicon-containing active material and reform into hybrid particles, high impact dry blending machines suitable for high shear mixing such as mechanochemical treatment or hybridization can be used.

In one embodiment, the mixing is performed by dry mixing. The term “dry mixing” as used herein, refers to a process of mixing components which are all in the dry state, i.e. not present in a dispersion or slurry or any other type of solution. The components may have a moisture content of less than 10 wt % during mixing. In a preferred embodiment, both the lignin and the at least one silicon-containing active material are in the form of a dry powder during the mixing step. Thus, the obtained lignin-silicon mixture is in the form of a dry powder.

By performing mixing by dry mixing, a simple process of mixing the lignin powder and the at least one silicon-containing active material powder is obtained. The dry mixing step is easily integrated with subsequent processing steps.

In one embodiment, the bulk density of the lignin-silicon powder mixture is in the range of from 0.3 to 0.5 g/cm³.

Step d) of the method according to the first aspect involves compacting the lignin-silicon powder mixture obtained in step c) so as to obtain a lignin-silicon composite material.

The term “lignin-silicon composite” as used herein, refers to a composite comprising lignin and one or more silicon-containing active material(s), e.g. a composite comprising lignin and elemental silicon, a composite comprising lignin and one or more silicon-rich compounds, or a composite comprising lignin, elemental silicon and one or more silicon-rich compounds. The term “lignin-silicon composite” further refers to a material comprising essentially only lignin and one or more silicon-containing active material(s), such that at least 95 wt %, or at least 98 wt %, based on the dry weight of the lignin-silicon composite material, of the lignin-silicon composite consists of lignin and one or more silicon-containing active material(s). The lignin-silicon composite may optionally also comprise small amounts, such as less than 5 wt %, or less than 2 wt %, based on the dry weight of the lignin-silicon composite material, of at least one additive. In the lignin-silicon composite, the one or more silicon-containing active material(s) is uniformly dispersed within a lignin matrix.

The compaction of the lignin-silicon powder mixture is preferably carried out by roll compaction. The roll compaction of the lignin-silicon powder mixture can be achieved by a roller compactor to agglomerate the lignin-silicon powder mixture.

In the compaction step, a compacted lignin-silicon intermediate is generated. Here, the fine lignin-silicon powder mixture is usually fed through a hopper and conveyed by means of a horizontal or vertical feeding screw into the compaction zone where the material is compacted into flakes by compaction rollers with a defined gap. By controlling the feeding screw speed, the pressure development in the compaction zone, flakes with uniform density can be obtained. The pressure development in the compaction zone can preferably be monitored and controlled by the rotational speed of the compaction rolls. As the powder is dragged between the rollers, it enters what is termed as the nip area where the density of the material is increased and the powder is converted into a flake or ribbon. The rolls used have cavities. The depth of each cavity used in the roll compaction is from 0.1 mm to 10 mm, preferably from 1 mm to 8 mm, more preferably from 1 mm to 5 mm or from 1 mm to 3 mm. The specific press force exerted during the compaction may vary depending on the equipment used for compaction, but may be in the range of from 1 kN/cm to 100 kN/cm. Equipment suitable for carrying out the compaction are known in the art.

In one embodiment of the roll compaction, the rolls configuration is such that the first roll has an annual rim in such configuration so that the powder in the nip region is sealed in the axial direction along the roller surface.

In one embodiment, the roll configuration is such that the nip region is sealed in the axial direction along the roller surface with a static plate. By ensuring that the nip region is sealed, loss of powder at the axial ends of the rollers is minimized as compared to entirely cylindrical nip rollers.

During compaction, a lignin-silicon composite material is formed as the materials in powder form are pressed together by mechanical pressure. The dispersion of silicon within the lignin matrix is improved as the particles of the respective powders are pressed into close proximity of each other, and further by entering the plastic phase.

The compaction may also act to enhance the interactions between the lignin particles and the silicon-containing active material particles in the composite, due to primary particle re-arrangement and plastic deformation induced by the mechanical force. The compaction will further act to ensure that the uniform distribution achieved in the mixing step is maintained until the lignin-silicon composite material can be further stabilized, i.e. by a thermal stabilization step.

Compaction may be carried out on a lignin-silicon powder mixture with no additives added. Alternatively, it may be carried out on a lignin-silicon powder mixture also comprising small amounts of at least one additive, such as less than 5 wt % based on the total dry weight of the lignin-silicon powder mixture.

Step e) of the method according to the first aspect involves crushing the lignin-silicon composite material obtained in step d) so as to obtain an agglomerated lignin-silicon composite material.

In the crushing step, the compacted lignin-silicon from the compaction step is subjected to crushing or grinding, such as by means of rotary granulator, cage mill, beater mill, hammer mill or crusher mill and/or combinations thereof. During this step, an agglomerated lignin-silicon composite material is generated.

The term “agglomerated lignin-silicon composite material” as used herein refers to macroscopic particles in turn comprising clustered smaller particles of lignin and at least one silicon-containing active material.

In some embodiments, the agglomerated lignin-silicon composite material comprises in the range of from 0.5 to 30 wt %, or from 2 to 20 wt %, of the silicon-containing active material, based on the dry weight of the agglomerated lignin-silicon composite material.

In some embodiments, the agglomerated lignin-silicon composite material comprises in the range of from 70 to 99.5 wt % lignin, based on the dry weight of the agglomerated lignin-silicon composite material.

In one embodiment, the agglomerated lignin-silicon composite material comprises from 70 to 99.5 wt % lignin, from 0.5 to 30 wt % of at least one silicon-containing active material, and from 0 to 5 wt % of at least one additive, based on the dry weight of the agglomerated lignin-silicon composite material.

Due to the compaction of the lignin-silicon powder mixture during preparation of the agglomerated lignin-silicon composite material, the bulk density of the lignin-silicon powder mixture will increase as pressure is applied to the powder. This means that the agglomerated lignin-silicon composite material will have a higher bulk density than the lignin-silicon powder mixture. A more compact material may be beneficial during subsequent processing to carbon enriched materials, as an agglomerated lignin-silicon composite material have been found to retain its shape and dimensions with no melting or swelling. The agglomerated lignin-silicon composite material will also have a relatively higher hardness after compaction. Hard particles are advantageous during subsequent processing as they can resist physical impact during processing.

The agglomerated lignin-silicon composite material preferably has a bulk density in the range of from 0.5 g/cm³ to 0.7 g/cm³. During the process of agglomeration, the bulk density of the material is increased as the material is compacted.

Step f) of the method according to the first aspect involves optionally sieving the agglomerated lignin-silicon composite material obtained in step e) so as to remove particles having a particle diameter below 100 μm, and obtain an agglomerated lignin-silicon composite material having a particle size distribution such that at least 80 wt % of the agglomerates have a diameter within the range of from 0.2 mm to 5.0 mm.

After crushing, the crushed material is preferably subjected to a sieving step, to remove fine material. In addition, large material, such as agglomerates having a diameter larger than 5.0 mm, may be removed and/or recirculated back to the crushing step.

In the sieving step, the agglomerated lignin-silicon composite material from the crushing step is screened by means of physical fractionation such as sieving, also referred to as screening, to obtain a product which is an agglomerated lignin-silicon composite material with a defined particle size distribution set by the porosity of the sieves or screens in this step. The sieve or screen is selected such that most particles having a diameter below 100 (or 500) μm pass through the screen and are rejected and preferably returned to the compaction step, whereas most particles having a diameter above 100 (or 500) μm are retained and subjected to the subsequent processing steps according to the present invention. The sieving may be carried out in more than one step, i.e. the sieving can be carried out such that the crushed material from the crushing step passes sequentially through more than one screen or sieve.

In a preferred embodiment, an agglomerated lignin-silicon composite material having a particle size distribution such that at least 80 wt % of the agglomerates have a diameter within the range of from 0.2 mm to 5.0 mm, preferably from 0.5 to 2.0 mm, is obtained after the sieving step.

The agglomerated lignin-silicon composite material preferably has a particle size distribution such that at least 80 wt % of the particles have a diameter in the range of from 0.2 mm to 5.0 mm. Preferably, the particle size distribution is such that at least 90 wt %, more preferably at least 95 wt %, of the particles have a diameter in the range of from 0.2 mm to 5.0 mm. More preferably, at least 90 wt %, more preferably at least 95 wt %, of the particles have a diameter in the range of from 0.5 mm to 2 mm.

In one embodiment, the method according to the first aspect involves an additional step g) that involves heating the agglomerated lignin-silicon composite material to a temperature in the range of from 140 to 250° C. for a period of at least 30 minutes, so as to obtain a thermally stabilized agglomerated lignin-silicon composite material.

The thermal processability of the agglomerated lignin-silicon composite material is further improved by performing a thermal stabilization. Thus, the processability of the lignin-silicon composite material in terms of avoiding melting/swelling and retaining shape and dimension during heating is improved both by forming agglomerates and by thermal stabilization of the formed agglomerates.

The term “thermal stabilization” as used herein, refers to a process of heating the agglomerated lignin-silicon composite material at a temperature lower than the temperature required for carbonization of the material. By performing a thermal stabilization, the agglomerated lignin-silicon composite material can be heat treated with retained shape and dimension, avoiding melting/swelling and deformation.

By thermal stabilization, the outer surface of the agglomerated lignin-silicon composite material is stabilized so that it becomes hard and can retain its shape and dimension. The interior of the agglomerates will also be subjected to heating, which will soften/melt the lignin and facilitate the dispersion of silicon within the lignin matrix.

The thermally stabilized agglomerated lignin-silicon composite material preferably has a bulk density in the range of from 0.5 g/cm³ to 0.7 g/cm³. The thermal stabilization might lead to a slight increase or decrease in bulk density of the lignin. The bulk density will however preferably remain within the same range as prior to the thermal stabilization.

The step of heating the agglomerated lignin-silicon composite material to produce the thermally stabilized agglomerated lignin-silicon composite material can be carried out continuously or in batch mode. The heating can be carried out using methods known in the art and can be carried out in the presence of air or completely or partially under inert gas. Preferably, the heating is carried out in a rotary kiln, moving bed furnace or rotary hearth furnace.

The heating to produce the thermally stabilized agglomerated lignin-silicon composite material is carried out such that the agglomerated lignin-silicon composite material is heated to a temperature in the range of from 140 to 250° C., preferably from 180 to 230° C. The heating is carried out for at least 30 minutes, i.e. the residence time of the agglomerated lignin-silicon composite material inside the equipment used for the heating is at least 30 minutes. In one embodiment, the heating is carried out for at least 1 hour, or at least 1.5 hours. Preferably, the heating is carried for less than 12 hours. The heating may be carried out at the same temperature throughout the entire heating stage or may be carried out at varying temperature, such as a stepwise increase of the temperature or using a temperature gradient. More preferably, the heating is carried out such that the agglomerated lignin-silicon composite material is first heated to a temperature in the range of from 140 to 175° C. for a period of at least 15 minutes and subsequently heated to a temperature in the range of from 175 to 250° C. for at least 15 minutes.

The thermally stabilized agglomerated lignin-silicon composite material comprises lignin, at least one silicon-containing active material(s) and optionally at least one additive. Compared to the agglomerated lignin-silicon composite material prior to heating to obtain the thermally stabilized material, there may be a small weight loss during the heating. The weight loss typically amounts to less than 15 wt % and is mainly due to evaporation of moisture and loss of volatiles due to decomposition of lignin during heating.

By controlling and optimizing parameters such as temperature and time during the thermal stabilization process, a thermally stabilized agglomerated lignin-silicon composite material that retains its shape and dimensions with no fusing or swelling during subsequent processing can be obtained. The described process has an excellent compatibility with the typical process requirements for continuous production, using rotary kiln for example, due to mechanical stability of the agglomerated lignin-silicon composite material and a relatively short residence time. This is of particular importance for achieving an economical large industry-scale process for producing carbon-silicon composite materials.

According to a second aspect, the present invention relates to an agglomerated lignin-silicon composite material obtainable by the method according to the first aspect. The agglomerated lignin-carbon composite material according to the second aspect may be further defined as set out above with reference to the first aspect.

According to a third aspect, the present invention relates to a method for producing a granular carbon-silicon composite material, wherein the agglomerated lignin-silicon composite material obtainable by the method according to the first aspect of the present invention is heat treated to obtain a granular carbon-silicon composite material.

Step i) of the method according to the third aspect involves providing an agglomerated lignin-silicon composite material obtainable by the method according to the first aspect.

By providing the lignin-silicon composite material in agglomerated form, a more compact and hard material is achieved. Hard particles are advantageous during subsequent processing as they can resist physical impact during processing. The agglomerated lignin-silicon composite material is further defined as set out above with reference to the first aspect.

Step ii) of the method according to the third aspect involves subjecting the agglomerated lignin-silicon composite material to heat treatment at one or more temperatures in the range of from 300° C. to 1500° C., wherein the heat treatment is carried out for a total time of from 30 minutes to 10 hours, so as to obtain a granular carbon-silicon composite material.

The term “heat treatment” as used herein, refers to a process of heating the agglomerated lignin-silicon composite material at one or more temperatures and for a sufficient time so that the lignin is converted to carbon. After heat treatment, the carbon content of the non-silicon parts of the composite material is higher than 80 wt %, or higher than 90 wt %, or higher than 95 wt %. Depending on the temperature during the heat treatment, different types of carbon, such as charcoal or hard carbon, can be obtained from lignin in the lignin-silicon composite material.

During the heat treatment, the components in the composite will become fully crosslinked and carbon is enriched by carbonization of lignin to create a granular carbon-silicon composite material.

The term “carbon-silicon composite material” as used herein in expressions such as “granular carbon-silicon composite material” and “carbon-silicon composite material powder”, refers to a composite comprising carbon which is derived from lignin, and at least one type of silicon-containing active material. The carbon-silicon composite material is obtained by heat treatment of the agglomerated lignin-silicon composite material described herein. In the carbon-silicon composite material, the at least one silicon-containing active material is uniformly dispersed within a carbon matrix.

Preferably, the heat treatment comprises a preliminary heating step, preferably followed by a final heating step. The preliminary heating step is preferably carried out at a temperature of between 30° and 800° C., such as between 50° and 700° C. The preliminary heating step is preferably carried out under inert atmosphere, preferably nitrogen atmosphere. The duration of the preliminary heating step is at least 30 minutes and preferably less than 10 hours. The preliminary and final heating steps may be carried out as discrete steps or as one single step in direct sequence. The surface area of the product obtained after the preliminary heating step is typically in the range of from 300 to 700 m²/g, measured as BET using nitrogen gas.

The final heating step is preferably carried out at a temperature between 800° C. and 1500° C. The final heating step is preferably carried out under inert atmosphere, preferably nitrogen atmosphere. The duration of the final heating step is at least 30 minutes and preferably less than 10 hours.

Preferably, the heat treatment is carried out stepwise. Preferably, the preliminary heating starts at about 300° C. and is subsequently increased to about 500° C. The final heating step is preferably carried out between 900° C. and 1300° C., such as at about 1000° C. After the final heating step carried out at 1000° C. or higher, the surface area of the product obtained is typically 10 m²/g or less.

The heat-treated material, i.e. the granular carbon-silicon composite material which is the product of step ii), preferably has a bulk density in the range of from 0.2 g/cm³ to 0.7 g/cm³. Depending on the amount and type of the silicon-containing active material in the agglomerated lignin-silicon composite material, the bulk density may remain in the same range or decrease (due to mass loss) after carbonization to a granular carbon-silicon composite material.

As the shape and dimension of the agglomerated lignin-silicon composite material is retained during heat treatment, the granular carbon-silicon composite material preferably has a particle size distribution such that at least 80 wt % of the granules have a diameter within the range of from 0.2 mm to 5.0 mm.

The heat-treated material, i.e. the granular carbon-silicon composite material which is the product of step ii) in the method according to the third aspect, is useful for example as bio-char, or as a precursor to activated carbon.

In one embodiment, the method according to the third aspect comprises an additional step of pulverizing the granular carbon-silicon composite material so as to obtain a carbon-silicon composite material powder. The pulverization may be performed by any suitable process, using for example a cutting mill, blade mixer, ball-mill, impact mill, hammer mill and/or jet-mill. Optionally, fine/coarse particle selection by classification and/or sieving may be performed subsequent to the pulverization.

The pulverization of the carbon-silicon composite material and optional fine/coarse particle selection may be performed so as to obtain a carbon-silicon composite material powder comprising powder particles having an average particle size (Dᵥ50) in the range of from 5 to 25 μm, as measured, for instance, by laser diffraction.

In one embodiment, more than one step of pulverizing or crushing is performed. In addition, the carbon-silicon composite material powder may be subjected to treatments such as coating or further heat treatments.

According to a fourth aspect, the present invention relates to a granular carbon-silicon composite material obtainable by the method according to the third aspect. The granular carbon-silicon composite material according to the fourth aspect may be further defined as set out above with reference to the third aspect.

As the agglomerated lignin-silicon composite material has a high loading of the at least one silicon-containing active material, and as the dispersion of the at least one silicon-containing active material is uniform within the lignin matrix, the granular carbon-silicon composite material obtained from heat treatment of the agglomerated lignin-silicon composite material will also benefit from a high loading and a uniform dispersion of the at least one silicon-containing active material within the carbon matrix.

According to a fifth aspect, the present invention relates to a carbon-silicon composite material powder obtainable by pulverizing the granular carbon-silicon composite material obtained by the method according to the third aspect. The carbon-silicon composite material powder may be further defined as set out above with reference to the third aspect.

The uniform distribution of silicon within the carbon matrix will remain also after pulverization. The obtained carbon-silicon composite material powder is thus suitable for use as active material in a negative electrode of a secondary battery, or in a battery-capacitor hybrid system, or in other material applications.

According to a sixth aspect, the present invention relates to a negative electrode for a non-aqueous secondary battery comprising the carbon-silicon composite material powder according to the fifth aspect as active material.

The carbon-silicon composite material powder obtained by pulverizing the granular carbon-silicon composite material is preferably used as an active material in a negative electrode of a non-aqueous secondary battery, such as a lithium-ion battery. When used for producing such a negative electrode, any suitable method to form such a negative electrode may be utilized. In the formation of the negative electrode, the carbon enriched material may be processed together with further components. Such further components may include, for example, one or more binders to form the carbon enriched material into an electrode, conductive materials, such as carbon black, carbon nanotubes or metal powders, and/or further Li storage materials, such as graphite or lithium. For example, the binders may be selected from, but are not limited to, poly(vinylidene fluoride), poly(tetrafluoroethylene), carboxymethylcellulose, natural butadiene rubber, synthetic butadiene rubber, polyacrylate, poly(acrylic acid), alginate, etc., or from combinations thereof. Optionally, a solvent such as e.g. 1-methyl-2-pyrrolidone, 1-ethyl-2-pyrrolidone, water, or acetone is utilized during the processing.

According to a seventh aspect, the present invention relates to use of the carbon-silicon composite material powder according to the fifth aspect as active material in a negative electrode of a non-aqueous secondary battery.

### EXAMPLES

### Example 1

Lignin powder obtained from the LignoBoost process was mixed together with 3 wt % nano-silicon powder, average primary particle size of 0.5 μm, using a V-mixer (200 rpm, 15 minutes). No additional additives were added. The mixture was then compacted and agglomerated by means of roller compaction at 50 kN and crushed/sieved into agglomerates to obtain an agglomerated lignin-silicon composite material with a size distribution of from 0.5 to 1.5 mm and a bulk density of 0.55 g/cm³.

The agglomerated lignin-silicon composite material was further thermally stabilized by heating inside a rotary kiln to 235° C. for 2 h in air to obtain a thermally stabilized agglomerated lignin-silicon composite material. During this process, the agglomerated lignin-silicon composite material did not exhibit any melting behaviour and completely retained its' original shape. It was found that the individual agglomerates did not fuse together and remained free flowing. The material gradually darkened during the processing until it was completely black and free of smell. The bulk density of the thermally stabilized agglomerated lignin-silicon composite material was 0.59 g/cm³.

This thermally stabilized agglomerated lignin-silicon composite was subsequently heat treated at 500° C. during 1 hour under inert atmosphere, to carbonize the material. This yielded a granular carbon-silicon composite material with retained shape/size. The bulk density of the granular carbon-silicon composite material was 0.58 g/cm³.

### Example 2

The same experimental details as for Example 1 were used, except that lignin powder was mixed with 3 wt % silicon oxide powder with an average primary particle size of 0.5 μm. No additional additives were added. The resulting agglomerated lignin-silicon composite material had a particle size distribution of from 0.5 to 1.5 mm and a bulk density of 0.56 g/cm³.

After heating, thermally stabilized agglomerated lignin-silicon composite material having a bulk density of 0.59 g/cm³ was obtained. The thermally stabilized agglomerated lignin-silicon composite material was subsequently carbonized to yield a granular carbon-silicon composite material having a bulk density 0.42 g/cm³.

### Example 3—Comparative Example

In this experiment, thermal conversion of conventional lignin powder was carried out. The lignin powder was not agglomerated prior to heat treatments.

Lignin powder from the LignoBoost process was heated to 200° C. for up to 12 h. After the heating, it was found that the lignin had melted/fused into a solid black cake free of smell.

In view of the above detailed description of the present invention, other modifications and variations will become apparent to those skilled in the art. However, it should be apparent that such other modifications and variations may be effected without departing from the spirit and scope of the invention.

1. A method for producing an agglomerated lignin-silicon composite material, said method comprising the steps of:
a) providing lignin in a form of a powder;
b) providing at least one silicon-containing active material in a form of a powder;
c) mixing the lignin, the at least one silicon-containing active material, and optionally at least one additive so as to obtain a lignin-silicon powder mixture;
d) compacting the lignin-silicon powder mixture obtained in step c) so as to obtain a lignin-silicon composite material;
e) crushing the lignin-silicon composite material obtained in step d) so as to obtain an agglomerated lignin-silicon composite material;
f) optionally sieving the agglomerated lignin-silicon composite material obtained in step e) so as to remove particles having a particle diameter below 100 μm, and obtain an agglomerated lignin-silicon composite material having a particle size distribution such that at least 80 wt % of agglomerates have a diameter within a range of from 0.2 mm to 5.0 mm.

2. The method according to claim 1, wherein a particle size distribution of the lignin is such that at least 80 wt % of particles have a diameter less than 0.2 mm and a moisture content of less than 45 wt %.

3. The method according to claim 1, wherein the lignin provided in step a) comprises Kraft lignin.

4. The method according to claim 1, wherein the at least one silicon-containing active material is microsized or nanosized.

5. The method according to claim 1, wherein the mixing is performed for at least 1 minute.

6. The method according to claim 1, wherein the mixing is performed at a mixing speed of at least 100 rpm.

7. The method according to claim 1, wherein the mixing is performed by dry mixing.

8. The method according to claim 1, wherein a bulk density of the obtained agglomerated lignin-silicon composite material is in a range of from 0.5 to 0.7 g/cm³.

9. The method according to claim 1, wherein the agglomerated lignin-silicon composite material comprises in a range of from 0.5 to 30 wt % of the at least one silicon-containing material, based on a dry weight of the agglomerated lignin-silicon composite material.

10. The method according to claim 1, wherein the at least one silicon-containing active material in the agglomerated lignin-silicon composite material is selected from a group consisting of: elemental silicon, a silicon suboxide, a silicon-metal alloy, and a silicon-metal carbon alloy.

11. The method according to claim 1, further comprising:
g) heating the agglomerated lignin-silicon composite material to a temperature in a range of from 140 to 250° C. for a period of at least 30 minutes, so as to obtain a thermally stabilized agglomerated lignin-silicon composite material.

12. The method according to claim 11, wherein the heating of the agglomerated lignin-silicon composite material is performed by first heating the agglomerated lignin-silicon composite material to a temperature in a range of from 140 to 175° C. for a period of at least 15 minutes and subsequently heating the agglomerated lignin-silicon composite material to a temperature in the range of from 175 to 250° C. for at least 15 minutes.

13. An agglomerated lignin-silicon composite material obtained by the method according to claim 1.

14. A method of producing a granular carbon-silicon composite material, comprising the steps of:
i) providing the agglomerated lignin-silicon composite material obtained by the method according to claim 1; and,
ii) subjecting the agglomerated lignin-silicon composite material to heat treatment at one or more temperatures in a range of from 300° C. to 1500° C., wherein the heat treatment is carried out for a total time in a range of from 30 minutes to 10 hours, so as to obtain a granular carbon-silicon composite material.

15. The method according to claim 14, wherein step ii) comprises a preliminary heating step, followed by a final heating step.

16. The method according to claim 15, wherein the preliminary heating step is carried out at a temperature of between 40° and 800° C. for at least 30 minutes, or wherein the preliminary heating step is carried out in an inert atmosphere, or both.

17. (canceled)

18. The method according to claim 15, wherein the final heating step is carried out at a temperature between 800° C. and 1500° C. for at least 30 minutes, or wherein the final heating step is carried out in an inert atmosphere, or both.

19. (canceled)

20. The method according to claim 14, further comprising:
pulverizing the granular carbon-silicon composite material so as to obtain a carbon-silicon composite material powder.

21. A granular carbon-silicon composite material obtained by the method according to claim 14.

22. (canceled)

23. A negative electrode for a non-aqueous secondary battery comprising:
the carbon-silicon composite material powder obtained by the method according to claim 20 as an active material.

24. (canceled)
